(19) United States
(12) Patent Application Publication
(10) Pub. No.: US 2006/0248788 A1
(43) Pub. Date: Nov. 9, 2006

(54) Candle for creating and pouring a body oil composition

(76) Inventor: Denise M. Harris, Springboro, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/418,477

(22) Filed: May 4, 2006

Related U.S. Application Data
(60) Provisional application No. 60/679,094, filed on May 9, 2005.

(51) Int. Cl. C11C 5/00

(52) U.S. Cl. 44/275

(57) ABSTRACT

A candle for pouring includes a container including a bowl having a continuous wall surface, wherein the continuous wall surface includes a pour spout, a soy-based candle composition formed inside the container, and at least one wick extending from the soy-based candle composition. A candle for pouring may also include an attached base section and at least one attached handle.

### CROSS-REFERENCE TO RELATED APPLICATION

This application claims the benefit of U.S. Provisional Patent Application Serial No. 60/679,094, filed May 9, 2005, the disclosure of which is incorporated herein by reference.

### FIELD OF THE INVENTION

The present invention generally relates to a candle for pouring and, more specifically, a soy-based candle composition formed within a container designed for pouring.

### BACKGROUND OF THE INVENTION

Candles have long been available for use as a lighting source or to create a relaxed atmosphere. Soy-based candles have also been available to be used as an alternative to or in combination with paraffin or wax candles. Massage oils have also long been available for use as an oil absorbed into the skin. Massage oils typically are distributed in a liquid state. Solid- state soy-based candles that become a soy-based massage oil when liquefied have been available, but they are packaged in cylindrical cans, which make a mess when pouring the melted massage oil.

### SUMMARY OF THE INVENTION

The present invention solves the above problem by combining solid-state soy- based candles that become a body oil or a massage oil when liquefied and a container for pouring.

The present invention is a candle for pouring comprising a container including a bowl having a continuous wall surface, wherein the continuous wall surface includes a pour spout, a soy-based candle composition formed inside the container, and at least one wick extending from the soy-based candle composition.

According to another embodiment of the present invention, the present invention is a candle for pouring comprising a container including a bowl having a continuous wall surface, a base section, and a handle, wherein the continuous wall surface includes a pour spout; wherein the base section is attached to a portion of the continuous wall surface; and wherein the handle is attached to a portion of the continuous wall surface. Furthermore, a soy- based candle composition is formed inside the container and at least one wick extends from the soy-based candle composition.

From the foregoing disclosure and the following detailed description of various preferred embodiments it will be apparent to those skilled in the art that the present invention provides a significant advance in the art of candle construction. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawing in which:

FIG. 1 is a perspective view of one representative embodiment of a candle for pouring.

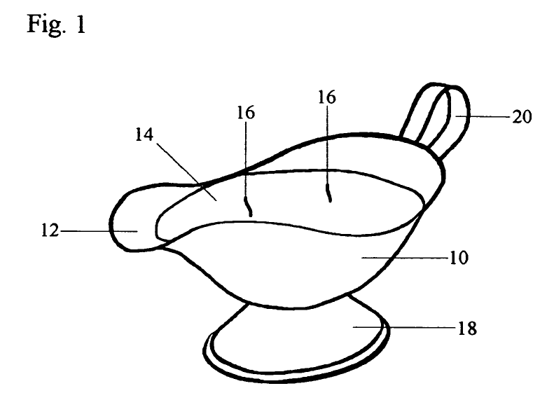

It should be understood that the appended drawing is not necessarily to scale, presenting a somewhat simplified representation of various preferred features illustrative of the basic principles of the invention. All references to direction and position, unless otherwise indicated, refer to the orientation of the object illustrated in the drawings.

### DETAILED DESCRIPTION OF THE PRESENT INVENTION

It will be apparent to those skilled in the art that many uses and design variations are possible for the candle for pouring disclosed herein. The following detailed discussion of various alternative and preferred embodiments will illustrate the general principles of the invention. Other embodiments will be apparent to those skilled in the art given the benefit of this disclosure.

The present invention is a candle for pouring designed to pour out the liquefied contents of the container 10. In a preferred embodiment of the present invention, a container includes a bowl having a continuous wall surface including a pour spout 12. Formed inside the container 10, a soy-based candle composition 14 exists. In this soy-based candle composition 14, at least one wick 16 extends.

A base section 18 is attached to the container 10. This base section 18 may enable the candle to more easily sit on a surface without tipping. This base section 18 may be temporarily or permanently attached to the container 10.

At least one handle 20 is attached to the container 10. The handle 20 will enable a user to pick up the container 10 to assist in pouring the liquefied soy-based composition 14 onto one's skin. Also, an attached handle(s) 20 may enable a user to more easily pick up the container 10 in order to move it. Furthermore, this handle 20 may be attached anywhere on the container 10 that would make it easily accessible to a user. In this embodiment, the handle 20 may be temporarily or permanently attached.

All embodiments of the present invention enable a user to pour the liquefied soy-based composition 14 from the container 10 onto a user's skin. In this manner, a user can then rub or massage the liquefied composition 14 onto the skin. It is therefore preferred that the candle composition liquefies at less than 98.6° Fahrenheit so as not to burn a persons skin if the melted composition is poured thereon. Consequently, since an exemplary embodiment of the present invention liquefies at approximately 72° Fahrenheit, a user's skin will not be burned or harmed by the application of the liquefied composition 14. Furthermore, in another embodiment of the present invention, the composition 14 is composed entirely of pure soy and natural oils. Because the exemplary composition 14 consists essentially of natural ingredients, the resulting liquefied composition 14 should be substantially harmless, and possibly beneficial, for a user's skin. The composition's 14 lack of wax or paraffin products further supports this aspect.

All embodiments of the present invention include at least one wick 16 extending from the soy-based composition 14. In an exemplary embodiment of the invention, all wicks 16 are manufactured from cotton, thus enabling clean burning.

Uses of the present invention may vary, but a preferred use of this invention begins by lighting the at least one wick 16. After the at least one wick 16 has burned for a short period of time, the composition 14 near the burning wick(s) 16 will have already liquefied. Depending on the length of the wick 16 and intensity of the flame, the composition 14 near the wick(s) 16 will liquefy in about 5-7 minutes. For safety, the burning wick(s) 16 will then be extinguished. The liquefied composition 14 then may act as a massage oil. Using the attached handle 20 and spout 12, this massage oil can be poured from the container 10 onto a user's skin. Once on the user's skin, the user or another person can rub or massage the oil into the user's skin. This rubbing or massaging may continue until the oil is completely absorbed by the skin or leave some oil residue on the user's skin.

Methods of making the present invention may also vary, but a preferred method of making a candle for pouring begins by heating a container to approximately 175° Fahrenheit. In this preferred method, soy flake (commercially available from Wix End in Centerville, Ohio) is added into the heated container until the soy flake is melted. The melted soy flake is then transferred into a stainless steel container. Then, approximately ¼ ounce of natural oils (also commercially available from Wix End in Centerville, Ohio) per 2 quarts of soy flake is added into the stainless steel container. These natural oils may be scented oils or unscented oils depending on the intended final product. The composition 14 is then cooled at approximately less than 32° Fahrenheit. After approximately 15 minutes of cooling the composition 14 is stirred. After approximately 35-37 minutes, the stainless steel container is removed from the cooling temperature environment. At this point, individual containers 10 can be used for individual candles, or the stainless steel container used in making the composition 14 may be used.

If using individual containers 10, prior to pouring the composition 14, at least one wick 16 is attached to each individual container 10. Then the composition 14 from the stainless steel container is poured into the individual containers 10. The composition 14 is allowed to harden for approximately more than 2 hours.

If using the stainless steel container used in making the composition 14 at least one wick 16 should be attached to the container prior to adding the soy flakes. The composition is allowed to harden for approximately more than 2 hours.

The apparatuses, uses, and methods disclosed herein have been described without reference to specific hardware. However, the apparatuses, uses, and methods disclosed herein have been described in a manner sufficient to enable persons of ordinary skill in the art to readily adapt commercially available hardware as may be needed to reduce any of the embodiments of the present invention to practice without undue experimentation.

It will be appreciated by persons skilled in the art that the present invention is not limited to what has been particularly shown and described in herein. The scope of the present invention is defined only by the claims which follow.

What is claimed is:

1. A candle for creating and pouring a body oil composition comprising:
a container including a bowl having a continuous wall surface, wherein the continuous wall surface includes a pour spout;
a soy-based candle composition formed and substantially solidified inside the container; and,
at least one wick extending from the substantially solidified soy-based candle composition.

2. The candle for pouring of claim 1, further comprising a base section, wherein the base section attaches to the continuous wall surface.

3. The candle for pouring of claim 1, further comprising at least one handle, wherein the at least one handle attaches to the continuous wall surface.

4. The candle for pouring of claim 1, wherein the soy-based candle composition consists essentially of pure soy and natural oils.

5. The candle for pouring of claim 1, wherein the soy-base candle composition is formulated to liquefy at below approximately 98.6° Fahrenheit.

6. The candle for pouring of claim 5, wherein the soy-based candle composition is formulated to liquefy at approximately 72° Fahrenheit.

7. The candle for pouring of claim 1, wherein the soy-based candle composition is composed of approximately 0.25 oz. of natural oils per approximately 2 quarts of soy.

8. A candle for creating and pouring a body oil composition comprising:
a container including a bowl having a continuous wall surface, a base section, and at least one handle, wherein the continuous wall surface includes a pour spout;
wherein the base section is attached to a portion of the continuous wall surface;
and wherein the at least one handle is attached to a portion of the continuous wall surface;
a body oil candle composition formed inside the container; and,
at least one wick extending from the body oil candle composition.

9. A candle for creating and pouring a body oil composition comprising:
a container including a bowl having a continuous wall surface, wherein the continuous wall surface includes a pour spout;
a body oil candle composition formed and substantially solidified inside the container; and,
at least one wick extending from the substantially solidified body oil candle composition.
